(19) United States
(12) Patent Application Publication
(10) Pub. No.: US 2003/0153230 A1
(43) Pub. Date: Aug. 14, 2003

(54) Resilient laminated textile product

(76) Inventor: Hung-Jung Chen, Taichung Hsien (TW)

Correspondence Address: Joseph W. Berenato, III, Liniak, Berenato, Longacre & White, LLC, 6550 Rock Spring Drive, Ste. 240, Bethesda, MD, 20817, US

(21) Appl. No.: 10/073,137

(22) Filed: Feb. 13, 2002

(51) Int. Cl. B32B 5/26

(52) U.S. Cl. 442/381

(57) ABSTRACT

A resilient laminated textile product includes top and bottom fabric sheets, and a lofty and resilient fibrous substance sandwiched by the top and bottom fabric sheets. The fibrous substance is elastic in a direction transverse to the top and bottom fabric sheets, and includes a stack of nonwoven fiber layers extending substantially perpendicular to the top and bottom fabric sheets.

### BACKGROUND OF THE INVENTION

1. Field of the Invention

The invention relates to a resilient laminated textile product, more particularly to a resilient laminated textile product that is lightweight and uneasily deformed, and that has good elasticity and air permeability.

2. Description of the Related Art

Conventional textile products, such as resilient fabric laminates and fabric pads, are generally fabricated by laminating a knitted fabric with a resilient foam, such as sponge, EVA, or neoprene rubber foam. While such foams provide good resiliency against compression, sponge is easily torn, deformed, and aged, whereas EVA and rubber foams are not air permeable. In addition, manufacturing processes of such products can produce environmentally harmful waste gases.

Fabric products with sandwich structures normally include two parallel knitted fabric layers and a fibrous support layer disposed between the two knitted fabric layers. The fibrous support layer is elastic and is connected to the two knitted fabric layers via needling. Since the fibrous support layer is integral with the knitted fabric layers, the fiber quantity and fiber length of the fibrous support layer are limited by the knitting machine which produced the knitted fabric layers so that the fibrous support layer cannot have a sufficient density. Thus, the conventional sandwich structure textile product has poor resistance against compression. Furthermore, the manufacturing process thereof is costly and is not environmentally safe.

Another type of fabric laminate, which is elastic and air permeable, includes an air permeable tufted fiber support layer disposed between two knitted fabric layers. Although the tufted fiber support layer is elastic, the laminate does not have a high degree of formability and recovering properties. The elasticity thereof is not good.

### SUMMARY OF THE INVENTION

Therefore, the main object of the present invention is to provide a resilient laminated textile product that is lightweight and uneasily deformed, and that has good elasticity and air permeability.

According to the present invention, a resilient laminated textile product comprises a top fabric sheet, a bottom fabric sheet, and a resilient and lofty fibrous substance. The resilient and lofty fibrous substance is sandwiched by the top and bottom fabric sheets, is elastic in a direction transverse to the top and bottom fabric sheets, and includes a stack of nonwoven fiber layers extending substantially perpendicular to the top and bottom fabric sheets.

### BRIEF DESCRIPTION OF THE DRAWINGS

Other features and advantages of the present invention will become apparent in the following detailed description of the preferred embodiment with reference to the accompanying drawings, of which:

FIG. 1 is an assembled sectional view of the preferred embodiment of a resilient laminated textile product according to the present invention;

FIG. 2 is a sectional view of a corrugated fiber web for use in the preferred embodiment;

FIG. 3 is a sectional view illustrating the fibrous substance obtained after cutting the corrugated fiber web; and

FIG. 4 illustrates a segment of a hollow fiber usable in the present invention.

### DETAILED DESCRIPTION OF THE PREFERRED EMBODIMENT

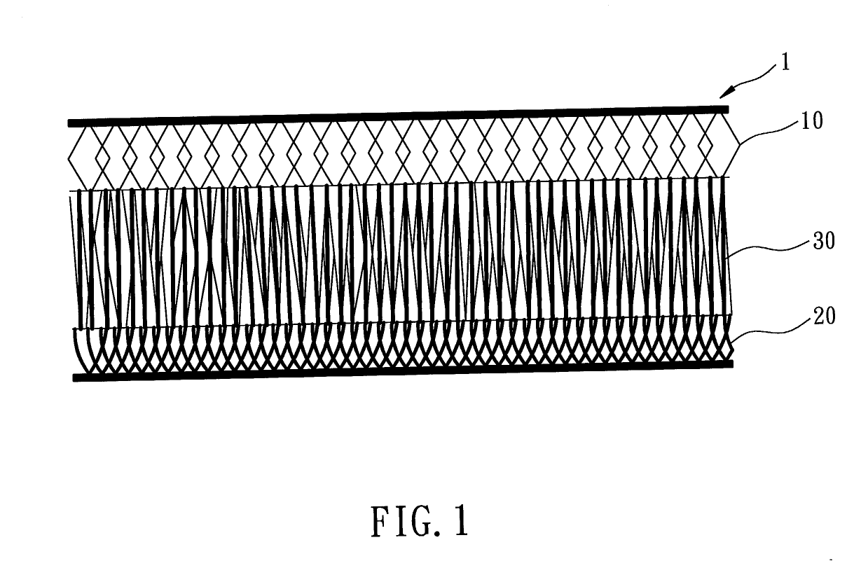

Referring to FIG. 1, a resilient laminated textile product 1 embodying the present invention is shown to include a top fabric sheet 10, a bottom fabric sheet 20, and a lofty and resilient fibrous substance 30 sandwiched by and bonded adhesively to the top and bottom fabric sheets 10, 20.

Each of the top and bottom fabric sheets 10, 20 may be a woven fabric formed by plain weaving, a knitted fabric, or a non-woven fabric. The fibers used for making the fabric sheets 10, 20 may be natural or synthetic fibers, or composite fibers.

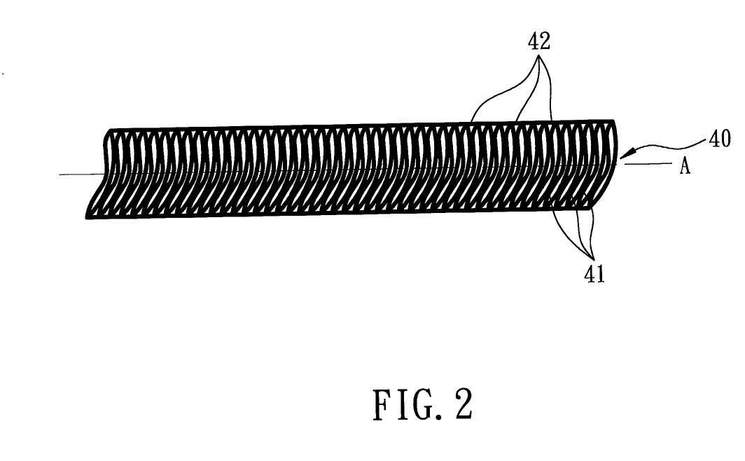

The lofty and resilient fibrous substance 30 is elastic in a direction transverse or perpendicular to the top and bottom fabric sheets 10, 20. The fibrous substance 30 is obtained from a corrugated fiber web 40, as shown in FIG. 2. The corrugated fiber web 40 is produced by corrugating a carded fiber web (not shown) via a corrugation process. As the corrugation process is conventional, it is not described and discussed herein for the sake of brevity. The carded fiber web may be fabricated via various conventional processes. The fibers used for fabricating the fiber web may be natural or synthetic fibers, or composite fibers. As embodied herein, the carded fiber web is prepared from a blend of hollow polyester and monofilament fibers, which is then mixed with thermal bonding polyester fibers having a low melting point as compared to the hollow polyester fibers and monofilament fibers. The aforesaid mixture of fibers is formed into a nonwoven fiber web via a conventional web forming process. Note that the fibers should be carded before being formed into the fiber web so that a substantial amount of the fibers are aligned in parallel in the formed fiber web. After the carded fiber web is corrugated to form the corrugated fiber web 40, it is fed into an oven so that the thermal bonding polyester fibers are fused and bond the hollow polyester and monofilament fibers together, thereby setting the shape of the corrugated fiber web 40.

The corrugated fiber web 40 has a light weight property due to the hollow polyester fibers, and the thickness thereof may be 20-40 mm. The corrugated fiber web 40 includes a stack of fiber layers 41 and a plurality of folds 42 each formed between two adjacent fiber layers 41. The fibers in each fiber layer 41 are substantially parallel since the fibers are carded.

For use in the present invention, the corrugated fiber web 40 may be cut into a plurality of pieces, according to a desired thickness, along lines parallel to a direction (A) shown in FIG. 2, which is transverse to the fiber layers 41. Alternatively, the corrugated fiber web 40 may be used directly without being cut.

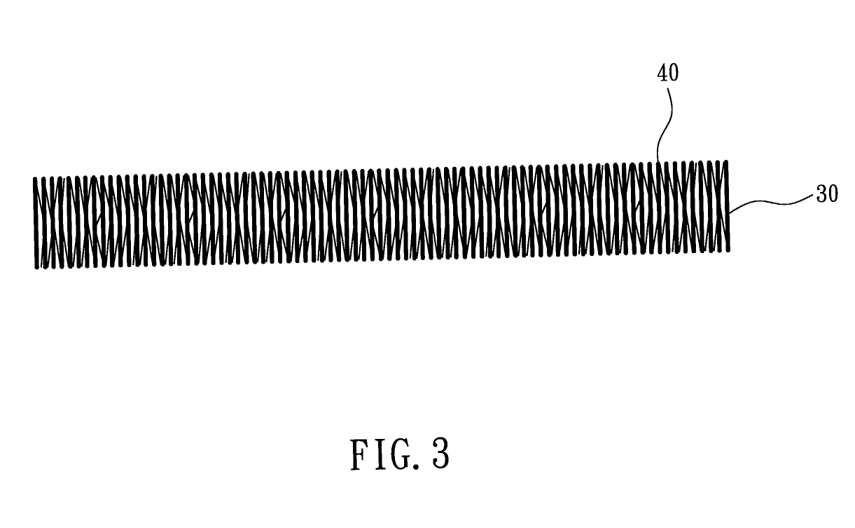

Referring to FIG. 3, in combination with FIG. 1, the lofty and resilient fibrous substance 30 is obtained by cutting the corrugated fiber web 40 as described hereinabove. The thickness of the fibrous substance 30 may be 2 mm, 3 mm, 4 mm, or other thickness as desired. The fibrous substance 30 obtained by cutting the corrugated fiber web 40 does not have the folds 42 of the corrugated fiber web 40, and has flat and smooth top and bottom surfaces. The fiber layers 41 in the fibrous substance 30 are parallel and extend transversely or substantially perpendicular to the top and bottom fabric sheets 10, 20. The fibrous substance 30 can provide good ventilation due to the parallel configuration of the fiber layers 41 therein. The density of the fibers in the fibrous substance 30 can be varied by extending the corrugated fiber web 40 along the machine direction of the fiber web which forms the corrugated fiber web 40.

The resilient laminated textile product 1 not only can provide cushioning and shock absorbing effects, but also has high capacity of elasticity retention due to the vertical and parallel orientation of the fiber layers 41. The laminated textile product 1 exhibits stable three dimensional configuration, good elasticity, and good air permeability, and is not easily deformed. In addition, it can provide a comfortable feeling and is suitable for use as pads in garments and shoes, such as cushions for upholstery.

Although the resilient laminated textile product 1 as described above includes three layers, the invention is not limited thereto. The present invention may include more than one layer of the fibrous substance 30 and more than two fabric sheets to form a laminated textile product having a plurality of layers other than three layers.

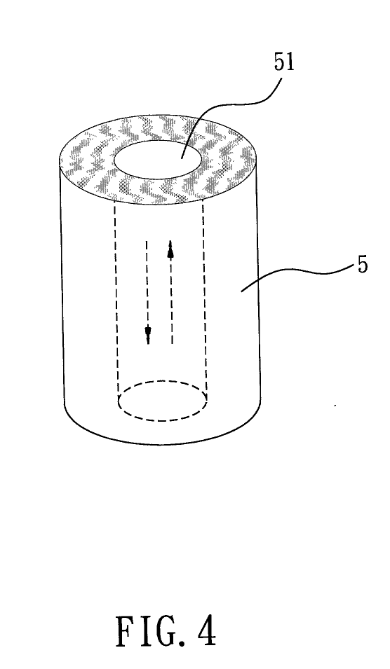

FIG. 4 shows a segment of a hollow fiber 5 usable in the present invention, which has a single through hole 51. Alternatively, the present invention may use a hollow fiber having more than one through hole, for instance, eight through holes, for increasing the ventilation effect of the fibrous substance 30.

The resilient laminated textile product 1 according to the present invention has the following advantages:

1. The product provides good ventilation due to the presence of hollow fibers, and good warming property.

2. The product is lightweight, and has excellent elasticity and good resistance against elastic fatigue.

3. The product can be formed into an article by a heat-sealing or heat-fusion process since the fibers used in the product may be thermoplastic fibers.

4. The thickness of the product can be increased to a certain extent without increasing the weight thereof too much due to the perpendicular orientation of the fibers and the structure of the hollow fibers. This is advantageous as compared to the conventional needle-punched fiber web layers which usually extend along the machine direction.

5. The fibrous substance 30 in the product of the present invention has a resistance against thermal compression as compared to sponge, the conventional sandwiched fiber webs, and knitted fabrics having tufted fibers.

6. The product can be produced from fibers formed from recycled wastes, such as waste PET bottles. This is beneficial for environmental conservation.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A resilient laminated textile product comprising:
a top fabric sheet;
a bottom fabric sheet; and
a resilient and lofty fibrous substance sandwiched by said top and bottom fabric sheets, said fibrous substance being elastic in a direction transverse to said top and bottom fabric sheets, and including a stack of nonwoven fiber layers extending substantially perpendicular to said top and bottom fabric sheets.

2. The resilient laminated textile product as claimed in claim 1, wherein said fibrous substance is produced by the steps of:
corrugating a carded nonwoven fiber web to form folds, and a plurality of stacked fiber layers each extending between successive ones of said folds; and
cutting said stacked fiber layers along a direction transverse to the direction of said fiber layers to form said stack of said nonwoven fiber layers of said fibrous substance.

3. The resilient laminated textile product as claimed in claim 2, wherein each of said top and bottom fabric sheets is selected from a group consisting of a woven fabric, a knitted fabric, and a non-woven fabric.

4. The resilient laminated textile product as claimed in claim 2, wherein said fibrous substance has a thickness of about 2-10 mm.

5. The resilient laminated textile product as claimed in claim 2, wherein said fibrous substance includes polyester fibers and thermal bonding fibers, said polyester fibers being bonded together by said thermal bonding fibers.

6. The resilient laminated textile product as claimed in claim 5, wherein said polyester fibers are hollow fibers, said thermal bonding fibers being made of polyester.
